(19) United States
(12) Patent Application Publication
(10) Pub. No.: US 2015/0132092 A1
(43) Pub. Date: May 14, 2015

(54) SELF-CONTAINED SELF-LEVELING MOVING AND STORAGE CONTAINER AND SYSTEM

(71) Applicant: Jack Rust Burrell, Parker, CO (US)

(72) Inventor: Jack Rust Burrell, Parker, CO (US)

(21) Appl. No.: 14/076,141

(22) Filed: Nov. 8, 2013

(51) Int. Cl. B60P 1/64; B65G 67/24; B65D 90/14; B62D 61/12

(52) U.S. Cl. CPC B60P 1/6454; B62D 61/12; B60P 1/6427; B65G 67/24; B65D 90/14
USPC 414/498; 280/30; 414/812; 414/809; 414/802; 220/1.5; 220/629

(57) ABSTRACT

A five-legged moving and storage container has self-leveling or self-raising ability: two wheeled legs at the second end of the device extend as the first end is pulled up a tilted tow truck bed. By extending the legs to raise the second end of the moving container at the same rate that the first end is pulled up the slope of the bed, the container is maintained level. As the tow truck bed is leveled, the legs can then be retracted to match and again the device remains level. No special infrastructure is required: it may be loaded and unloaded in any location having a normal flat-bed tow truck. It may have three additional legs at the other end: one in the middle with a wheel, two at the corners without, allowing it to raise itself or be raised and stabilized at dock height.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### CROSS-REFERENCE TO RELATED APPLICATIONS

N/A

### FIELD OF THE INVENTION

This invention relates generally to moving and storage containers and use of them in the industry of retail moving and storage and in support of commercial applications, and specifically to “pod” type containers.

### STATEMENT REGARDING FEDERALLY FUNDED RESEARCH

This invention was not made under contract with an agency of the US Government, nor by any agency of the US Government.

### BACKGROUND OF THE INVENTION

“Pods”, “Pack Rat”, “Units” and similar moving and storage devices are light containers, quite different from shipping containers and not built to ISO specifications, which are taken to an individual's home or business and left there.

The individual then loads up the small moving and storage container and when they are ready, the container is retrieved.

However, these small containers may come with one large disadvantage: lifting and moving these containers requires the use of a specialized lifting mechanism. One example of a level lifting device is the “Podzilla”. Podzilla is the tradename used for the product covered by U.S. Pat. Nos. 7,811,044, 6,155,770, and 6,071,062 in the name of Warhusrt. The popular Podzilla® device allows the company to deliver a small moving and storage pod to a driveway or parking lot and yet maintain the “pod” level at all times.

Video of this device may be seen at https://www.youtube.com/watch?v=6pJop3ZxnHc.

This appears to be an excellent system until one recalls that the Podzilla® device costs approximately $150,000. In addition, the “pod” container can only be used in an area having a franchise device for lifting the container into place to be loaded and can only be sent to another area having another franchise device for lifting the container into place to be unloaded. At $150,000 for an extremely specialized device, this substantially limits the universality of the system and thus the geographic extent to which it can be used.

Other types of containers are unlikely to suit the needs of typical moving clients, who need their possessions kept level. A roll-off container is designed to be hoisted at an angle, since it is normally used for bulk cargo or refuse. ISO shipping containers are over-engineered for home moving, also lack any “level moving” system and most standards sizes are much too large for a standard household move.

Various devices are known for combatting this problem. U.S. Pat. No. 2,937,879 to Lion on May 24, 1960 is an example of a heavy duty shipping container with four extendible legs, but lacking any self-leveling device, lacking a fifth-leg, and lacking a suggestion to combine with a standard tow-truck in a method embodiment.

U.S. Pat. No. 3,476,275 to Cowlishaw et al on Nov. 4, 1969 teaches another load-carrying appliance somewhat similar to the Podzilla® device discussed previously.

U.S. Pat. No. 5,169,194 to Yamashita et al on Dec. 8, 1992 and U.S. Pat. No. 5,203,670 to Yoneda et al on Apr. 20, 1993 teach a container lifting device which is raised level with two extendible legs at the rear end. However, it is raised using a truck specially equipped to first raise it directly vertically and then drag it horizontally forward. This not only lacks any suggestion for combination with a standard equipped flat-bed tow truck, since it suggests a specialized vehicle, it actually teaches away from combination with a standard flat-bed tow-truck, away from elimination of the special handling equipment and so on.

It would be preferable to provide a way to raise and lower a standard moving container of straightforward construction, even non-ISO standard, to the level of a normal flat-bed tow truck (which has a tilting “flat” bed) and yet keep the container itself level.

### SUMMARY OF THE INVENTION

### General Summary

The present invention teaches a small moving and storage container, which is unlike a standard ISO container and unlike a shipping container as it may be of different construction (meaning of construction similar to that of a semi-van for trucks as opposed to ISO shipping containers) and additionally of smaller size than the stereotypical ISO shipping container. The moving and storage container of the invention has a self-leveling ability which may be manual or automated: two legs at the second end of the device extend as the first end is pulled up a slanted tow truck bed. By extending the legs to raise the second end of the moving container at the same rate that the first end is pulled up the slope, the container is maintained in a level configuration for the entire time. The legs end up on the rear end of the flat bed of the tow truck, so that as the tow truck bed is leveled, the legs can then be refracted and once again the device remains level. Thus as the bed of the truck is lowered at the front end and raised at the back end, the legs are retracted at a proportionate rate so that both bed and moving container remain level throughout the process. The legs thus can assume any length from fully retracted position to fully extended position.

The device of the invention may then be transferred to a long-distance conveyor such as a truck or train: the small size of the moving container, in the preferred embodiment smaller than a standard shipping container, allows it to fit easily on truck flat beds, inside of semi-vans and so on. Note that it may come in various sizes: it could be quite small, large or even in alternative embodiments the size of an ISO container, though of different structure and construction.

The device can be used in almost any location, as no special infrastructure is required: it may be loaded and unloaded in any location having a flat-bed tow truck.

For the consumer, the cost savings are enormous. Rather than paying for the use of a $150,000 machine, the consumer merely pays for a single trip of a tow-truck, that is, an amount likely to be much smaller.

The device may have legs which extend enough to keep it level across the typical angle of a flat-bed tow-truck in relation to the length of the container (tangent(angle)*length) in the elevated position, or it may have legs which are long enough to allow it to be raised to a “dock height” in the elevated position. While there is no standard dock height, it is normally between 40 and 50 inches.

The device further has additional legs at the first end. At the corners of the first end are legs lacking any wheels at the bottom: these legs allow the device to remain stably supported in an upright configuration, either for use at a “dock height” and also for the ability to level and stabilize the container in a residential driveway, which typically slopes downward toward a street. It also has a third leg between the two wheel-less legs at the first end, this allows it to be moved in the elevated position. The three legs at the first end all may extend and retract in a manner similar to those at the second end.

The self-leveling device in a manual embodiment may be a control box on a cable: the box may simply have buttons for “raise” “lower” and so on for different legs. In an automated embodiment, an accelerometer, gyro, or level may be monitored by a microprocessor having non-volatile memory programmed with a leveling, raising and lowering module to assure that it remains level by controlling the extension of the legs.

The third leg, the leg in the middle of the first end of the device, may be extended and retracted by variable amounts, so as to allow the device to be leveled on typical driveways, which often have a slope. It also allows the device to be raised to dock height prior to extending of the corner legs on that end (the fourth and fifth legs of the device), and since it has a swiveled wheel on the bottom, it further allows modest adjustments of the device's position.

The invention may also be easily handled by means of forklifts, as it will have forklift slots on the ends and sides. In use the device may be brought to a warehouse or transport terminal on a tow-truck. While the winch of the tow-truck is useful for getting the moving container onto the tow-truck, it will not function to get the moving container into a dry van semi-trailer or onto a flat-bed train carriage or the like. Thus the standard forklift can be used to pick up the device off the tow-truck and move it to a storage location (such as stacked with other similar moving containers) or place it into a semi-van, a train carriage, etc. At the receipt end of the transportation system, another standard forklift may be used to lift it from the van/carriage and onto another standard tow-truck. The tow-truck can lower the moving container merely by raising the bed, releasing the winch and allowing it to slide off gently, while self-leveling with the first and second legs.

### SUMMARY IN REFERENCE TO CLAIMS

It is therefore another aspect, advantage, objective and embodiment of the invention, in addition to those discussed previously, to provide a self-leveling, self-contained moving and storage container for use with a standard flat-bed tow truck, the moving and storage container comprising:
a body having first and second ends, having at least one door, a floor four walls and a ceiling forming a right-angled parallelepiped shape with an interior;
the body having at the second end first and second legs, one leg disposed near each corner of the second end, each of the first and second legs having a first refracted position in which the second end of the body is not elevated, and having a second fully extended position in which the second end of the body is elevated, and having the ability to assume any position between the first retracted position and the second fully extended position whereby the container may remain level when the first end is on a surface higher than the second end;
the body having at the first end a third leg; the third leg disposed intermediate the corners of the first end; the third leg having a retracted position in which the first end of the body is not elevated, and having a second fully extended position in which the first end of the body is elevated, and having the ability to assume any position between the first retracted position and the second fully extended position;
the body having at the first end fourth and fifth legs, one leg disposed near each corner of the first end, each of the fourth and fifth legs having a first retracted position in which the first end of the body is not elevated, and having a second fully extended position in which the second end of the body is elevated, and having the ability to assume any position between the first retracted position and the second fully extended position;
each of the legs having an extension/retraction mechanism operative to extend and retract the leg.

It is therefore another aspect, advantage, objective and embodiment of the invention, in addition to those discussed previously, to provide a self-leveling, self-contained moving and storage container for use with a standard flat-bed tow truck, the moving and storage container further comprising:
each of the first and second legs having on the bottom end a wheel;
the third leg having on the bottom end a swivel wheel
the body having at the first end casters, disposed so as to allow the first end to roll upon the casters when the second end is elevated.

It is therefore another aspect, advantage, objective and embodiment of the invention, in addition to those discussed previously, to provide a self-leveling, self-contained moving and storage container for use with a standard flat-bed tow truck, the moving and storage container further comprising:
a plurality of apertures through the floor, one aperture disposed at each leg, so that in the retracted positions the legs may extend upward into the body;
a plurality of covers, one cover disposed at each leg, each cover dimensioned and configured to separate its respective leg from the interior of the body.

It is therefore another aspect, advantage, objective and embodiment of the invention, in addition to those discussed previously, to provide a self-leveling, self-contained moving and storage container for use with a standard flat-bed tow truck, the moving and storage container for use with a standard flat-bed tow truck, the moving and storage container further comprising: an automatic leveling module operative to control the position of at least the first and second legs and further operative to extend, retract, and maintain the position of the first and second legs so as to maintain the body in a level configuration while the body moves along such bed of such flat-bed tow truck despite any tilt of such bed.

It is therefore another aspect, advantage, objective and embodiment of the invention, in addition to those discussed previously, to provide a self-leveling, self-contained moving and storage container for use with a standard flat-bed tow truck, the moving and storage container, for use with a standard flat-bed tow truck, the moving and storage container further comprising: a manual leveling module operative to control the position of at least the first and second legs and further operative to extend and retract the first and second legs so as to maintain the body in a level configuration while the body moves along such bed of such flat-bed tow truck.

It is therefore another aspect, advantage, objective and embodiment of the invention, in addition to those discussed previously, to provide a self-leveling, self-contained moving and storage container for use with a standard flat-bed tow truck, the moving and storage container wherein each of the fourth and fifth legs has on the bottom end no wheel, and further wherein the automatic leveling module is further operative to control the position of the third leg, and to extend and retract the third leg.

It is therefore another aspect, advantage, objective and embodiment of the invention, in addition to those discussed previously, to provide a self-leveling, self-contained moving and storage container for use with a standard flat-bed tow truck, the moving and storage container for use with a standard height loading dock, wherein the elevated position further comprises: dock height.

It is therefore another aspect, advantage, objective and embodiment of the invention, in addition to those discussed previously, to provide a self-leveling, self-contained moving and storage container for use with a standard flat-bed tow truck, the moving and storage container for use with a standard flat-bed tow truck having an ability to tilt such flat-bed to an angle “A”, wherein:
the moving and storage container body further comprises a length “L”,
and wherein the elevated position further comprises a height given by the formula: height=tangent(A)*L.

It is therefore another aspect, advantage, objective and embodiment of the invention, in addition to those discussed previously, to provide a self-leveling, self-contained moving and storage container for use with a standard flat-bed tow truck, the moving and storage container further comprising: at least ¼″ thickness sidewalls and roof, 1⅜ inch laminated hardwood floors, and flange I beams of 2″ width.

It is therefore yet another aspect, advantage, objective and embodiment of the invention to provide a method of moving and storing items from a first location, the method comprising: providing a standard flat-bed tow truck having a winch and a rear end of the bed;
providing a storage container having first and second ends, the storage container dimensioned and configured to fit upon the bed of the flat-bed tow truck; the storage container having a first pair of legs located at the second end of the storage container; the storage container disposed upon the bed of the flat-bed truck, the storage container having casters at the first end;
conveying the storage container to such first location;
attaching the winch to the storage container;
tilting the bed of the flat-bed tow truck while extending the first pair of legs;
maintaining the length of the first pair of legs equal to the height of the first end of the storage container as the bed of the tow-truck is tilted;
whereby the storage container remains level despite the increasing tilt of the bed of the flat-bed tow truck;
rolling the container off of the tow truck slowly by means of the winch and the action of gravity;
retracting the first pair of legs so as to maintain the first pair of legs equal to the height of the first end of the storage container on the bed of the flat-bed tow truck as the container rolls off of the rear end of the bed of the tow truck;
whereby the storage container remains level while rolling off of the tow truck to a ground surface;
allowing placement of such items into the storage container.

It is therefore yet another aspect, advantage, objective and embodiment of the invention to provide a method of moving and storing items from a first location, the method further comprising:
returning the flat-bed tow truck to such first location and moving the rear end of the bed of the flat-bed tow truck to the first end of the storage container;
tilting the bed of the flat-bed tow truck;
attaching the winch to the container;
pulling the storage container up onto the tilted bed of the flat-bed tow truck using the winch, with the first end of the storage container first;
extending the first pair of legs downward from the second end of the storage container;
maintaining the length of the first pair of legs equal to the height of the first end of the storage container as it is pulled up onto the tilted bed of the flat-bed tow truck;
whereby the storage container remains level despite the tilt of the bed of the flat-bed tow truck;
leveling the tilted bed of the flat-bed tow truck while retracting the first pair of legs so as to maintain the length of the first pair of legs equal to the height of the first end of the storage container as the bed of the flat-bed tow truck is leveled;
whereby the storage container remains level despite the leveling of the bed of the flat-bed tow truck;
conveying the storage container from such first location.

It is therefore yet another aspect, advantage, objective and embodiment of the invention to provide a method of moving and storing items from a first location, the method further comprising:
providing a storage facility;
providing a standard forklift at the storage facility;
conveying the storage container to the storage facility;
lifting the storage container with the standard forklift, conveying it into the storage facility and setting it down;
storing the storage container at the storage facility.

It is therefore yet another aspect, advantage, objective and embodiment of the invention to provide a method of moving and storing items from a first location, the method further comprising:
providing a second storage container at such facility, the second storage container having the same construction as the storage container; and
wherein the step of lifting and setting down the storage container with the standard forklift further comprises:
stacking the storage container atop the second storage container.

It is therefore yet another aspect, advantage, objective and embodiment of the invention to provide a method of moving and storing items from a first location, the method further comprising:
providing a long-distance vehicle;
transferring the storage container to the long-distance vehicle by the steps of:
attaching the winch to the storage container;
tilting the bed of the flat-bed tow truck while extending the first pair of legs;
maintaining the length of the first pair of legs equal to the height of the first end of the storage container as the bed of the tow-truck is tilted;
whereby the storage container remains level despite the increasing tilt of the bed of the flat-bed tow truck;
rolling the container off of the tow truck slowly by means of the winch and the action of gravity;
retracting the first pair of legs so as to maintain the first pair of legs equal to the height of the first end of the storage container on the bed of the flat-bed tow truck as the container rolls off of the rear end of the bed of the tow truck;
whereby the storage container remains level while rolling off of the tow truck;
providing a standard forklift;
removing the tow-truck and backing the long-distance vehicle to either side of the storage container;
lifting the storage container onto the long-distance vehicle by using the forklift on one side of the storage container;
conveying the storage container on the long-distance vehicle.

It is therefore yet another aspect, advantage, objective and embodiment of the invention to provide a method of moving and storing items from a first location, the method further comprising:
providing a long-distance vehicle;
transferring the storage container to the long-distance vehicle by the steps of:
attaching the winch to the storage container;
tilting the bed of the flat-bed tow truck while extending the first pair of legs;
maintaining the length of the first pair of legs equal to the height of the first end of the storage container as the bed of the tow-truck is tilted;
whereby the storage container remains level despite the increasing tilt of the bed of the flat-bed tow truck;
rolling the container off of the tow truck slowly by means of the winch and the action of gravity;
retracting the first pair of legs so as to maintain the first pair of legs equal to the height of the first end of the storage container on the bed of the flat-bed tow truck as the container rolls off of the rear end of the bed of the tow truck;
whereby the storage container remains level while rolling off of the tow truck;
providing a standard forklift and a standard loading dock;
lifting the storage container onto the standard loading dock by using the forklift on one side of the storage container;
removing the tow-truck and backing the long-distance vehicle to either end of the storage container on the standard loading dock;
rolling the storage container into the long-distance vehicle using the forklift to push from the other end of the storage container while allowing the casters to roll;
conveying the storage container on the long-distance vehicle.

It is therefore yet another aspect, advantage, objective and embodiment of the invention to provide a method of moving and storing items from a first location, for use at such first location wherein such first location is a commercial establishment having a loading dock, and further wherein:
the step of allowing placement of such items into the storage container, is preceded by a step of extending the first pair of legs and extending a third leg distal the first two legs so as to raise the container to the height of such commercial facility loading dock, then extending fourth and fifth legs for stability prior to the step of allowing placement of items into the storage container; and further wherein
the step of allowing placement of items into the storage container is followed by a step of simultaneously retracting the first pair of legs and the third leg so as to lower the loaded storage container below the height of such commercial facility loading dock while maintaining the loaded storage container level.

It is therefore yet another aspect, advantage, objective and embodiment of the invention to provide a method of moving and storing items from a first location, for use at a second location, further comprising the steps of:
conveying the storage container to such second location;
attaching the winch to the storage container;
tilting the bed of the flat-bed tow truck while extending the first pair of legs;
maintaining the length of the first pair of legs equal to the height of the first end of the storage container as the bed of the tow-truck is tilted;
whereby the storage container remains level despite the increasing tilt of the bed of the flat-bed tow truck;
rolling the container off of the tow truck slowly by means of the winch and the action of gravity;
retracting the first pair of legs so as to maintain the first pair of legs equal to the height of the first end of the storage container on the bed of the flat-bed tow truck as the storage container rolls off of the rear end of the bed of the tow truck;
whereby the storage container remains level while rolling off of the tow truck;
allowing removal of such items from the storage container.

It is therefore yet another aspect, advantage, objective and embodiment of the invention to provide a method of moving and storing items from a first location, for further use at a second location, the method further comprising;
providing a second standard flat-bed tow truck;
transferring the storage container from the long-distance vehicle to the second flat-bed tow truck by the steps of:
providing a second standard forklift;
pulling the storage container from the long-distance vehicle using the forklift to pull from one end of the storage container while allowing the casters to roll;
lifting the storage container onto the flat-bed tow truck by using the forklift on one side of the storage container;
conveying the storage container to such second location on the second flat-bed tow truck;
tilting the bed of the second flat-bed tow truck while extending the first pair of legs so as to maintain the length of the first pair of legs equal to the height of the first end of the storage container as the bed of the second flat-bed tow truck is titled;
lowering the storage container down from the tilted bed of the second flat-bed tow truck with the second end first;
maintaining the length of the first pair of legs equal to the height of the first end of the storage container as it is lowered down off of the tilted bed of the second flat-bed tow truck;
whereby the storage container remains level despite the tilt of the bed of the flat-bed tow truck bed.

It is therefore yet another aspect, advantage, objective and embodiment of the invention to provide a method of moving and storing items from a first location, wherein the storage container further comprises a normal storage container construction not meeting ISO standards, the storage container dimensioned and configured to fit onto a standard conveyance including but not limited to trailers selected from the group consisting of: standard flat-bed trailers, standard dry van semi-trailers and combinations thereof and within standard size ISO containers.

It is therefore yet another aspect, advantage, objective and embodiment of the invention to provide a method of moving and storing items from a first location, wherein such long-distance vehicle further comprises one member selected from the group consisting of: a standard flat-bed trailer and semi-tractor, a dry van semi-trailer, a train, a ship, an airplane and combinations thereof.

It is therefore yet another aspect, advantage, objective and embodiment of the invention to provide a moving and storage container for use with a standard flat-bed tow truck, the moving and storage container comprising:
a body having first and second ends, having at least one door, a floor four walls and a ceiling forming a right-angled parallelepiped shape with an interior;
the body having at the second end first and second legs, one leg disposed near each corner of the second end, each of the first and second legs having a first refracted position in which the second end of the body is not elevated, and having a second fully extended position in which the second end of the body is elevated, and having the ability to assume any position between the first retracted position and the second fully extended position;
each of the legs having at the bottom end a wheel, the wheel having thereon a swivel.

It is therefore yet another aspect, advantage, objective and embodiment of the invention to provide a moving and storage container for use with a standard flat-bed tow truck, the moving and storage container further comprising: a leveling module operative to control the position of at least the first and second legs and further operative to extend, retract, and maintain the position of the first and second legs so as to maintain the body in a level configuration while the body moves along such bed of such flat-bed tow truck.

### BRIEF DESCRIPTION OF THE DRAWINGS

FIG. 1 is aside view of a standard flat-bed tow truck with the bed inclined (“tilted”) and a moving container according to the invention resting on the ground.

FIG. 2 is a side view of a standard flat-bed tow truck with the bed inclined and the moving container of the invention pulled upward on the inclined bed but still level due to the extension of first and second legs at the second end of the container to match the vertical motion of the first end of the moving container.

FIG. 3 is a side view of a flat-bed tow truck with the bed now leveled and the moving container still level due to the retraction of the first and second legs to match the lowering of the first end of the moving container.

FIG. 4 is a flow chart showing the steps of the method of moving items of the invention.

FIG. 5 is an elevated perspective view of a moving container of the invention sitting on the ground with a standard tow-truck having the bed inclined.

FIG. 6 is an elevated perspective view of the moving container of the invention sitting at a height on the inclined bed but leveled by the extension of the legs equal to the height of the first end of the moving container.

FIG. 7 is an elevated perspective view of the moving container of the invention with the bed leveled and the moving container leveled due to the retraction of the legs to match the lowering of the first end of the moving container.

FIG. 8 is a perspective view of the moving container.

FIG. 9 is a perspective view of the moving container of the invention raised with the rear legs extended and the front legs retracted as if sitting on an inclined surface.

FIG. 10 is a perspective view of moving container raised to dock height

FIG. 11 is a perspective view of the moving container of the invention raised and with the wheel-less legs lowered to secure it into place in a stable dock high position so that a forklift could be driven in for commercial loading.

FIG. 12 is a low-angle perspective view of the moving container of the invention with all legs retracted, showing the apertures of the floor of the container.

FIG. 13 is a low-angle perspective view of the moving container of the invention with the legs of the second end extended, showing how the moving container may self-level while being raised up an inclined surface such as a standard tow truck bed.

FIG. 14 is a low-angle perspective view of the moving container of the invention with three wheeled legs extended, allowing the moving container to roll on a level surface, and also raised to a dock high position.

FIG. 15 is a low-angle perspective view of the moving container of the invention with all five legs extended, holding the container stable and motionless in the elevated position, such as for a loading or unloading activity at a commercial operation such as a business or industrial site.

FIG. 16 is a side view of a rail carriage having the doors open to show the self-contained and self-leveling moving and storage container of the invention within.

FIG. 17 is a high-angle oblique perspective view of a single retracted leg of the moving container of the invention.

FIG. 18 is a high-angle oblique perspective view of a single extended leg of the moving container of the invention.

FIG. 19 is a low-angle oblique perspective view of a moving and storage container of the invention showing the legs at one end partially extended to offset the effect of a slanted surface, such as a sloped driveway, a tow truck bed in an intermediate state and so on.

FIG. 20 is a side view of a moving and storage container of the invention showing the legs at one end partially extended to offset the effect of a slanted surface, such as a sloped driveway, a tow truck bed in an intermediate state and so on.

FIG. 21 is a high-angle oblique perspective view of a semi-van and truck with a moving and storage container of the invention loaded therein and the doors omitted to show the moving and storage container.

FIG. 22 is a high-angle oblique perspective view of a truck and flat-bed trailer with three of the moving and storage containers of the invention loaded thereon.

FIG. 23 is a low angle oblique view of a container of the invention showing a two legged embodiment.

FIG. 24 is a view of a forklift conveying the container from the side, for example to place it on/in a long distance vehicle, and the doors of the invention.

FIG. 25 is a view, end on to the container and side view of a forklift carrying the container of the invention, showing the relative vertical relationship of a refracted leg and a caster.

FIG. 26 is a side view of a forklift and container of the invention, showing the handling points (fork lift slots) and how the end furthest from the forklift may roll upon the casters.

FIG. 27 is a high angle oblique view showing the handling points (fork lift slots) and how the end furthest from the forklift may roll upon the casters.

### INDEX TO REFERENCE NUMERALS

Moving container body 2
First end of body 3
Tow truck bed 4
Second end of body 5
Tow truck 6
Manual self-leveling control 7
Rear end of bed 8
Automated self-leveling control 9
Front end of bed/winch 10
Body (container) length 11
Point of contact/casters 12
Wheel swivel 13
First leg 14
Dock height 15
First leg wheel 16
Dock 17
Sleeve 18
Interior/Floor 20
Point of contact/casters 22
Third leg 24
Aperture 25
Third leg wheel 26
Aperture 27
Adjustable height fifth leg 28
Fourth/Fifth leg wheel-less foot 29,30
Storage container construction 32
Refracted position leg 34
Extended position leg 36
Caster 37
Extension/retraction mechanism 38
Cable of winch 39
Drive 40
Winch 41
Semi-van 42
Moving and storage container 44
Moving and storage containers 46a, 46b, 46c
Rail carriage van 50
Doors 52
Moving and storage container 54
Forklift slots 56
Moving and storage container 60
First leg 62
Second leg 64
Providing standard flatbed tow truck 102
Providing storage container 104
Allowing placement of items 106
Driving the tow truck to moving container 108
Tilting truck bed 110
Pulling moving container up inclined bed 112
Extending legs 114
Maintaining length of legs equal to height 116
Leveling the bed while retracting the
legs to match 118
Conveying away 120
Providing long-distance vehicle 122
Transferring container 124
Conveying on long-distance vehicle 126
Providing second standard tow truck 128
Transferring to second tow truck 130
Conveying to second location 132
Tilting bed while extending legs 134
Lowering container 136
Maintaining legs length equal to height 138
Doors 202
Forklift 204
Refracted leg w/wheel 206
Caster 208
Handling point (fork slots) 210

### DETAILED DESCRIPTION

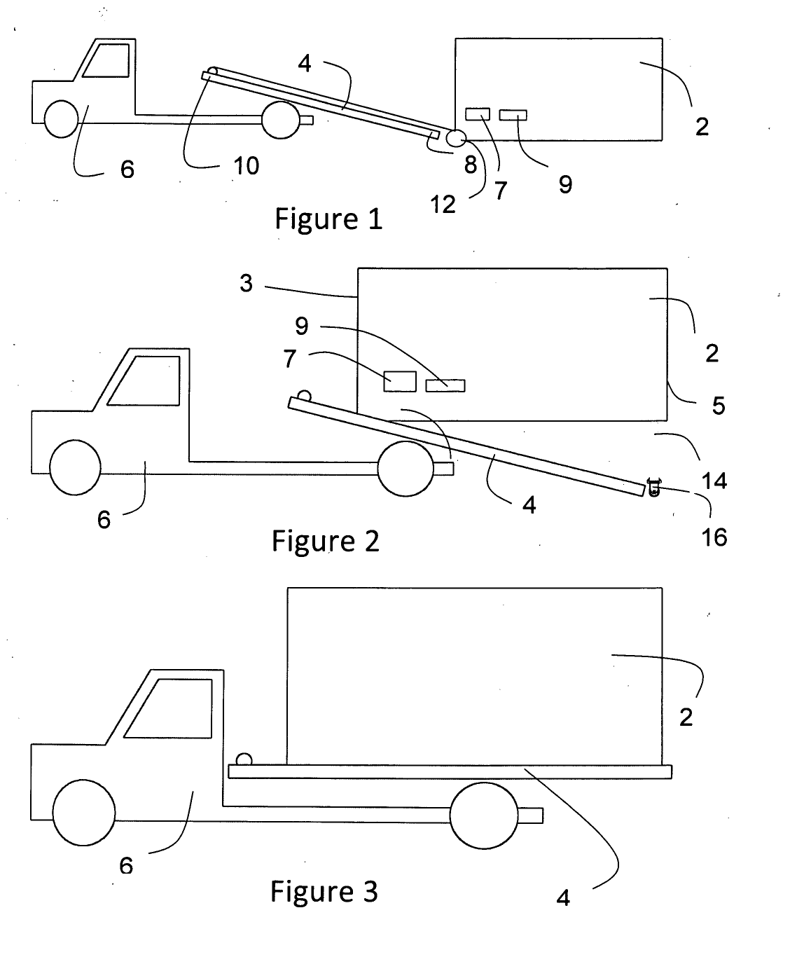

In a preferred embodiment and best mode now contemplated for carrying out the invention, FIG. 1 is a side view of a standard flat-bed tow truck with the bed inclined (“tilted”) and a moving container according to the invention resting on the ground, while FIG. 2 is a side view of a standard flat-bed tow truck with the bed inclined and the moving container of the invention pulled upward on the inclined bed with the use of the tow truck's winch pulling it, but still level due to the extension of first and second legs at the second end of the container to match the vertical motion of the first end of the moving container. Moving/storage container body 2 has a floor, a roof/ceiling, four walls and at least one entranceway. In the diagrams the second end of the body (rear-ward on the orientation of the truck but frontward on the body 2 itself) is shown open, as a door. It forms a right-angled parallelepiped, which is a rectanguloid box.

First end of body 3 is closest to tow truck bed 4, while the second end 5 of the body 2 is farthest from the tow truck 6.

The tow truck 6 is a standard flat-bed tow truck.

The name to the contrary, a flat-bed tow truck actually tilts or inclines the flat bed in order to load a car. As shown in FIGS. 1 and 2, the flat-bed 4 slopes down to the ground (in some cases also extending rear-ward as well). For an incapacitated car, a powerful winch then hauls the vehicle up onto the bed at a high slope and then the flat-bed is leveled as shown in FIG. 3.

For a storage or moving container 2, this process would be a problem, and thus the prior art all teaches away from the use of a standard tow truck: a tilted moving container would immediately result in the shifting of the loaded goods within, causing damage and an extremely unhappy customer. This is also the explanation for the popularity of the Podzilla® device. However, the present invention, as shown in FIG. 2, allows an ordinary tow-truck to serve the purpose of hauling a moving container without tilting it.

Manual self-leveling control 7 in some embodiments or on the other hand automated self-leveling control 9 in alternative embodiments are used to maintain the level of the moving container 2. While the rear end of the bed 8 is much lower than the front end of the bed 10, and while the point of contact during motion 12 rises up this ramp as pulled by the tow truck's winch, first leg 14 and the matching second leg on the same end (FIG. 6) are extended downward under the direction of the self-leveling control 7/9.

Note that the extension of the legs may vary so as to maintain the device in a level orientation during this process. That is, while the height of the body 2 is low, the extension of the legs 14 is low, but as the height increases the extension increases to match. The same process applies in reverse for leveling of the tilted bed of the truck a few moments later, and the same process applies as the bed is later (after being conveyed away) tilted again to remove the moving/storage container 2, and yet again, in reverse again, for the process of sliding the container down the bed while retracting the legs 14 to match the decreasing elevation/height.

Wheel swivel 13 (in some embodiments only present on wheel 26) is an option allowing easier rolling of the device, but it may not be present in all embodiments.

First leg wheel 16 however is either desirable or is necessary in equivalent structure: the rear legs 14 will snap off or deform under use if they are not able to move across the surfaces under the body 2 when it is being pulled. It will be understood that the 3 wheels on the legs provide the device with different capabilities. The wheels on the bottom of the first and second legs are necessary so that the body may be smoothly pulled to the rear of a tow truck and even up onto a slanted tow truck bed. On the other hand, the wheel on the leg at the other end (the third leg in this embodiment) allows adjustment, angling and positioning of the device which would not be possible without a wheel. Finally, the two wheel-less legs four and five are for stability: extended, they provide the body with corner-wise stability at or near all four corners when raised.

In alternative embodiments, fewer legs might be used but they will be provided with wheels and swivels which lock, thus allowing the device to be locked in place.

For purposes of this application, it will be understood that a leg situation “at” a corner of the body may be near the corner of the body, geometrical precision is not indicated. “Near” in turns means close enough to provide stability when the body is raised to dock height.

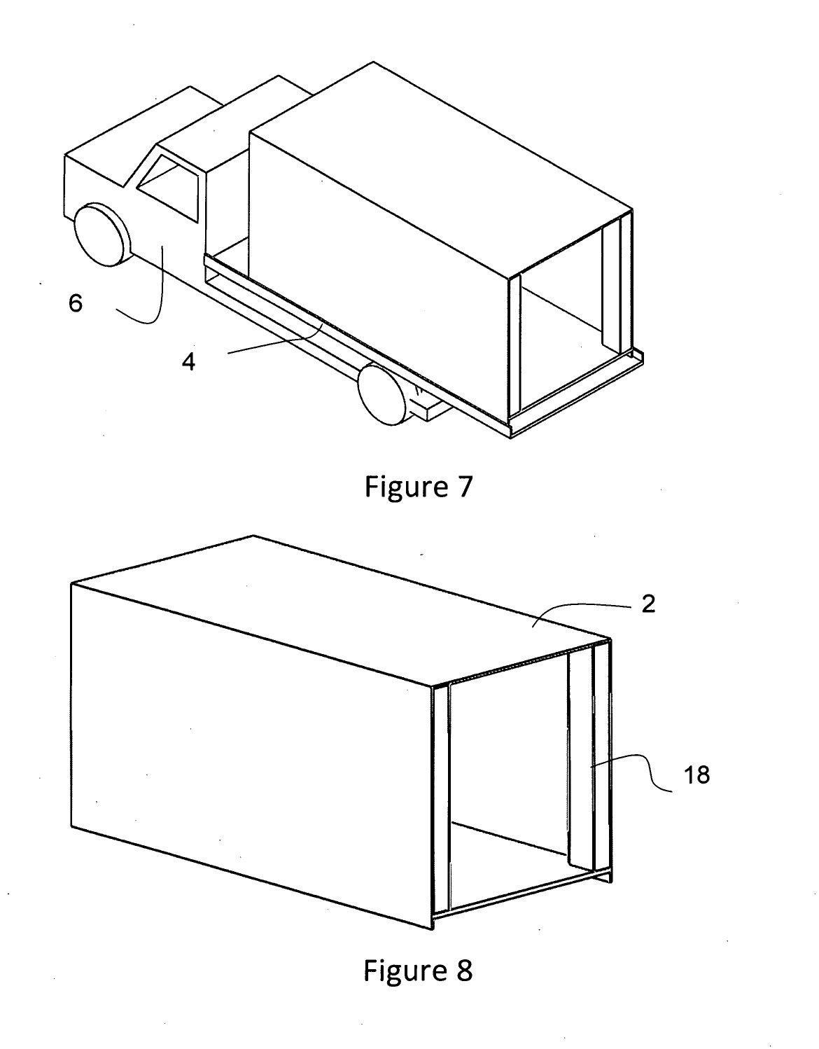

Sleeve 18 and Interior/Floor 20 are all visible in FIG. 5 et seq. Point of contact has or is casters 22 which of course move from one end of the bed to the other as the invention is raised up the bed. As the point of contact 12/22 moves along the bed, the height/elevation of the body 2 increases, and the extension of legs 14 increases as well, from a fully retracted position to a position extended enough to keep the body 2 level while at the maximum height attained during operations. (The maximum height will be discussed below in reference to FIG. 5.)

FIG. 3 is a side view of a flat-bed tow truck with the bed now leveled and the moving container still level due to the retraction of the first and second legs to match the lowering of the first end of the moving container. The moving container 2 is thus now in position to be driven away on the back of truck 6, trans-shipped to other types of vehicles and so on.

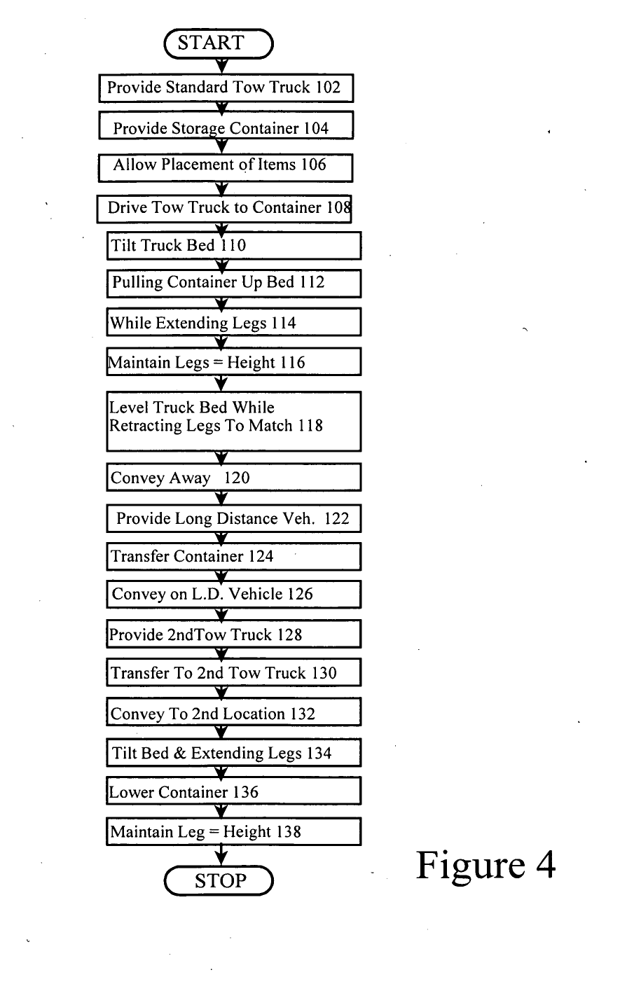

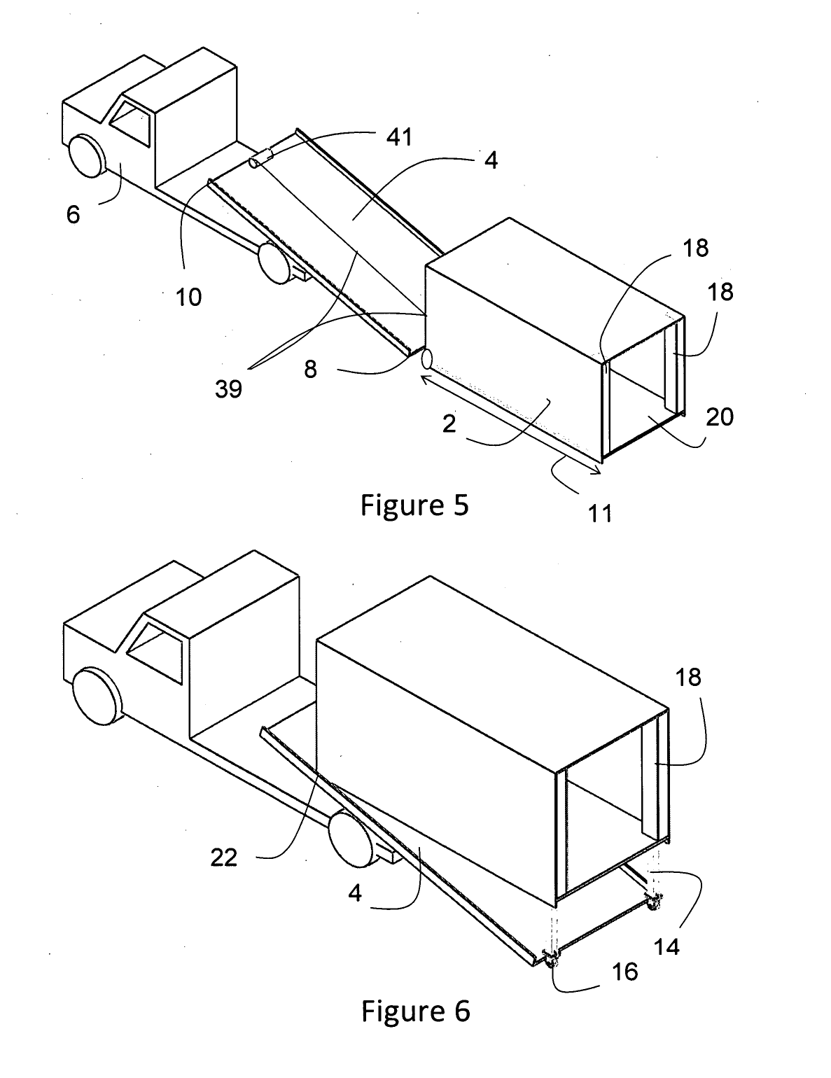

FIG. 4 is a flow chart showing the steps of the method of moving items of the invention. After starting, (presumably by means of a consumer or business requesting moving or storage service) the process is as follows.

Providing standard flat-bed tow truck, step 102, is the point at which the invention demonstrates a rather marked economic advantage over previous systems.

In nearly all parts of the US, providing a standard tow truck is extremely easy, inexpensive, quick and requires no special equipment. This is in direct contrast to prior art systems using special equipment such as fork lifts or the like.

Providing storage container step 104 is just as easy: the consumer (including a business) can be provided with the storage container step 104 simply by means of the standard tow truck dropping it off. Note that between this step and the next step, the container may be raised to the dock height of a commercial facility having a dock, so as to allow a commercial facility to conveniently use the device at dock height. This can be done simply by extending the first, second and third legs simultaneously (at the same rate) so as to maintain the container level.

Allowing placement of items 106 provides the customer with time to load the moving container. After this step, the device may be lowered back to ground level by retracting legs one through three while maintaining the device level. It will be seen that in the case of a commercial facility, this allows the facility to use the loading dock, and yet does not require a forklift or other special equipment, merely a standard flat-bed tow truck for delivery and pickup.

Driving the tow truck to the moving container, step 108, is followed by tilting the tow truck bed, step 110, into the configuration shown in the FIGS. 1 and 2 and others. The tow truck is equipped for both this operation and for the next step, 112, of pulling moving container up inclined bed by means of a hoist, winch, block, wheel chock and so on.

Extending legs 114 and maintaining the length of the legs equal to the height of the container as it is hoisted up a standard tow truck bed, step 116, is the step which makes the present invention both desirable to the consumer and extremely economical compared to other methods.

Leveling the bed while retracting the legs to match the leveling at step 118 is necessary to get the truck and moving container in a safe configuration for conveying away (120) the moving container from the first location at which it was loaded with items.

Providing long-distance vehicle, step 122, is optional, as the majority of typical household moves takes place within a single metropolitan area and thus can be done with a single tow truck. However, for other purposes a long distance vehicle including a semi-truck, train, airplane, ship or combinations thereof is contemplated. This may be common in commercial applications. Transfer of the storage container may occur by several methods: the forks of a forklift will be long enough in most embodiments to allow a forklift to simply lift the device from the side. From the ends, a forklift may in embodiments not be able to support the full weight of the storage container but this is not usually an issue as the storage container has casters/rollers/wheels built into the lower edge of the end, whereby a forklift can simply lift it at the near end by a very small amount (an inch, a few inches, or less, thus keeping it substantially level) and then the forklift can easily pull or push the device in or out of a semi-van, a loading dock, onto or off of a flat-bed trailer, or move it about the interior or precincts of a commercial facility. This flexibility allows for a wide range of ordering of the steps of the invention as claimed. Thus as defined herein, the device may be “maintained at dock height” by its own legs, or by being rolled in and out of a semi-van directly onto a dock, and so on.

Transferring the moving container 124 and conveying it on the long-distance vehicle (step 126) follow, and at the destination it is also straightforward to provide a second standard tow truck 128, transfer the moving container to the second tow truck at step 130, and convey it to a new, second location 132. The device is equipped with forklift slots at the ends and sides, so that a standard forklift can be used to pick up the device off the tow-truck and move it to a storage location (such as stacked with other similar moving containers) or place it into a semi-van, a train carriage, etc. Later another forklift may be used to lift it from the van/carriage and onto another tow-truck bed. The tow-truck can lower the moving container merely by raising the bed and allowing it to slide off gently, while self-leveling with the first and second legs.

In general, the device will be transferred from a van or other space in which only the ends are accessible by inserting the forks of the forklift into the slots and then pulling it gently backward and out of the van. This may be done at dock height. Once at dock height, forks may be withdrawn from the end slots and instead the side slots may be used by the forklift to raise the device (this time with the entire weight stably supported and lifted by the forklift) and place it in a new location sideways, or for example, a semi-van may be backed up to a dock, the forklift may pull the device from the semi-van by the end, then a tow truck may be backed up to the dock and the forklift can simply push the device forward again, this time onto the flat bed of the tow truck. It will be understood that this pulling and pushing do not necessarily require the device to be entirely supported from the end by the forklift, which in embodiments is not done. Rather forks can be inserted at one end, the end lifted until it is barely clear of the ground (an inch or even less) and then the rollers/casters at the far end allow the forklift to back up pulling the device, etc.

Offloading of the shipping container from the second tow truck is the converse process (not quite a mirror image) of the steps of loading it. That is, the bed is tilted while the legs are extended to maintain the level configuration, (step 134), then the container is lowered (for example by gravity)

Lowering of the container step 136 is the point at which the legs are refracted rather than extended in order to carry out the crucial maintaining legs length equal to height, step 138.

A short summary explanation of how a commercial establishment might be most likely to use the device is as follows.

The container can be unloaded by a flat bed tow truck onto ground level, once the container is on the ground the legs 1 and 2 and the single leg 5 on end 1 will be raised to match the height of the dock or dock door allowing it to be loaded or unloaded and maintaining the same level elevation as the dock or dock door. Once the container is loaded or unloaded and ready to be transported the flat bed tow truck will return, lower all the legs back to a ground position tilt the bed of the tow truck and use the same loading procedure as at a residence.

Note that this is not the only possible set of steps in the process, as many variations are possible within the scope of the appended claims.

FIG. 5 is an elevated perspective view of a moving container of the invention sitting on the ground with a standard tow-truck having the bed inclined. Cable 39 of winch 41 may be seen attached to the container.

Body length 11 is shown. This figure is important for determining leg length, as will be discussed below in reference to FIG. 10.

FIG. 6 is an elevated perspective view of the moving container of the invention sitting at a height on the inclined bed but leveled by the extension of the legs equal to the height of the first end of the moving container. FIG. 7 is an elevated perspective view of the moving container of the invention with the bed leveled and the moving container leveled due to the retraction of the legs to match the lowering of the first end of the moving container and the leveling of the tow truck bed.

FIG. 8 is a perspective view of the moving container of the invention sitting on the ground with the doorway open for loading.

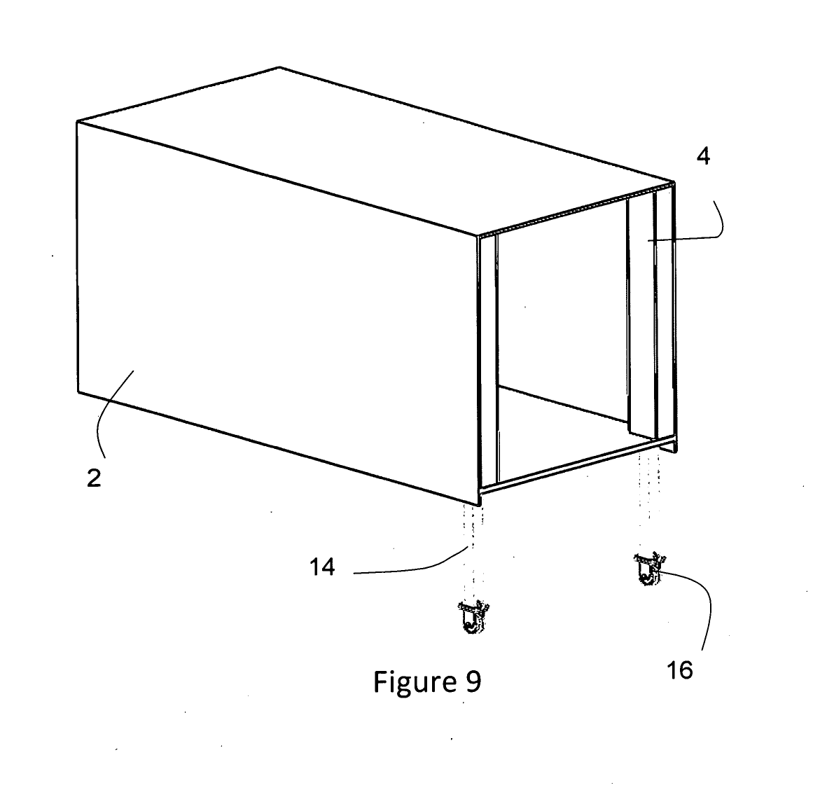

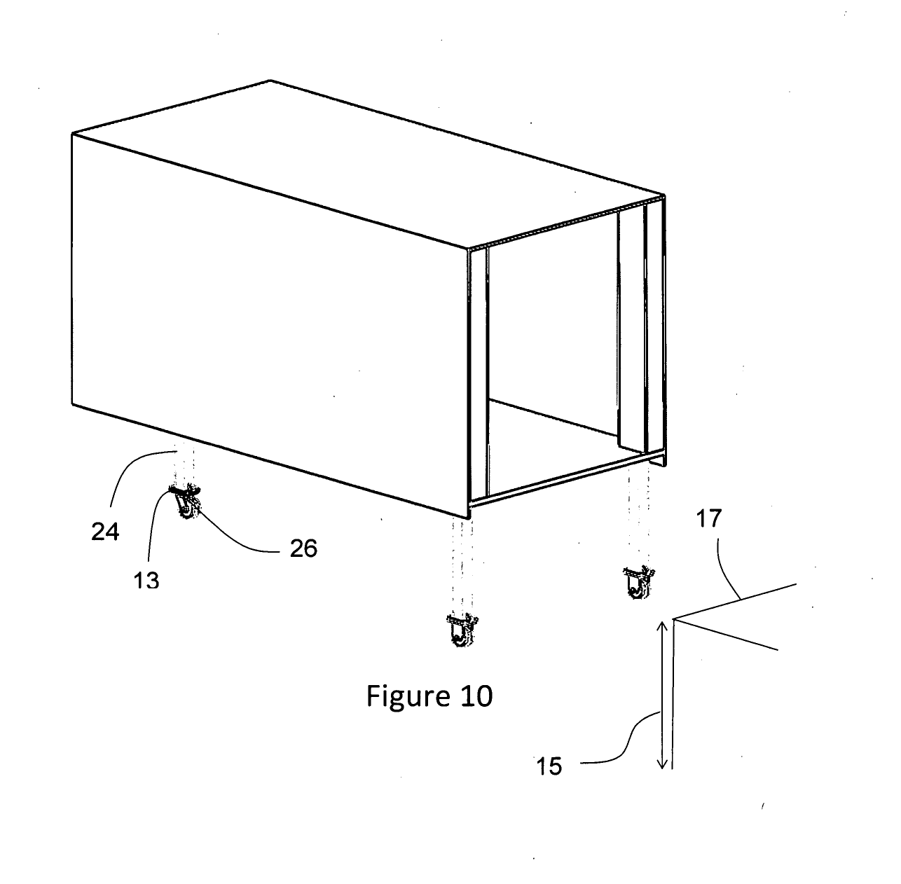

FIG. 9 is a perspective view of the moving container of the invention raised with the rear legs extended and the front legs retracted as if sitting on an inclined surface. Obviously the inclined surface intended is a tilted bed of a tow truck but it may be used in other ways.

For example, known moving containers do not sit level by themselves while customers load them, and most US driveways are very slightly slanted. The present invention allows the customer the option of having the moving container be more level than their own driveway.

Usually, the opposite leg extension might be expected: the third leg is used for leveling of the container while the first and second legs are retracted.

FIG. 10 is a perspective view of moving container elevated/raised to dock height 15, which in the US is usually about 40 to 50 inches. Thus in one preferred embodiment and best mode now contemplated, business customers can be served by having the container brought to their loading dock 17.

On the other hand, there is a certain important minimum length for the legs which must be used in order to keep the moving container flat while being loaded or unloaded. First, the legs must have sufficient extra length for the refraction/extension equipment to physically engage the leg, and for the leg to penetrate the floor 20 of the body 2, and so on. This “utility” length of the leg is termed “C”, a constant. This part of the overall length may not be available for extension. The body 2 further comprises a length 11, expressed here as “L”, as seen in FIG. 5. The tow truck in turn is able to achieve an angle “A” with the bed.

Thus the elevated position should at a minimum in preferred embodiments be:

Height=tangent(A)*L+C
It is understood that in the present invention, the length of the legs is defined by the angle a standard tow-truck bed may slant, and this is an important element of the invention as claimed.

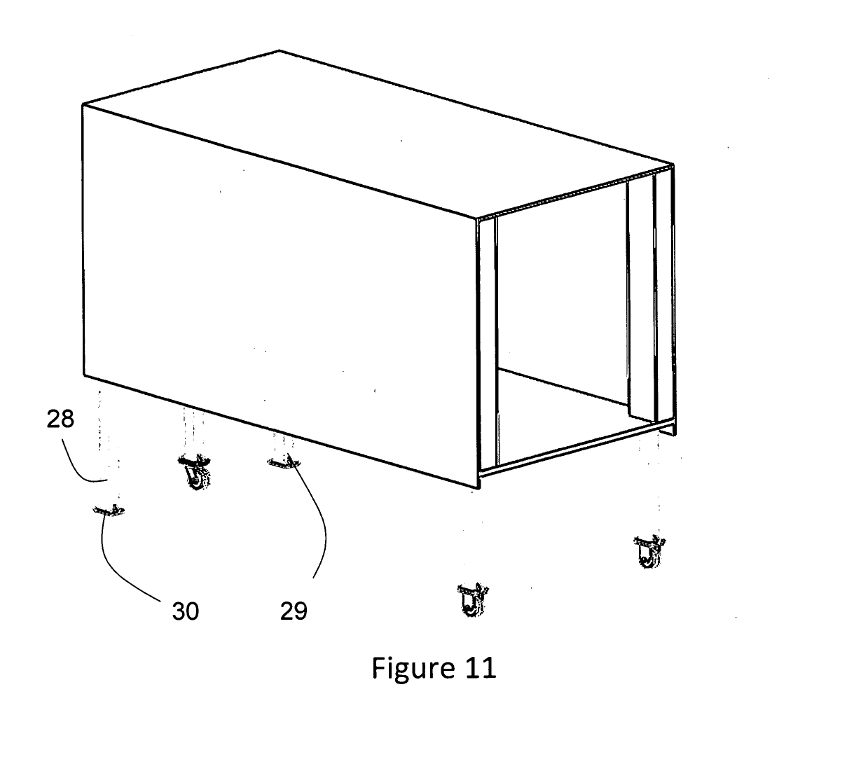

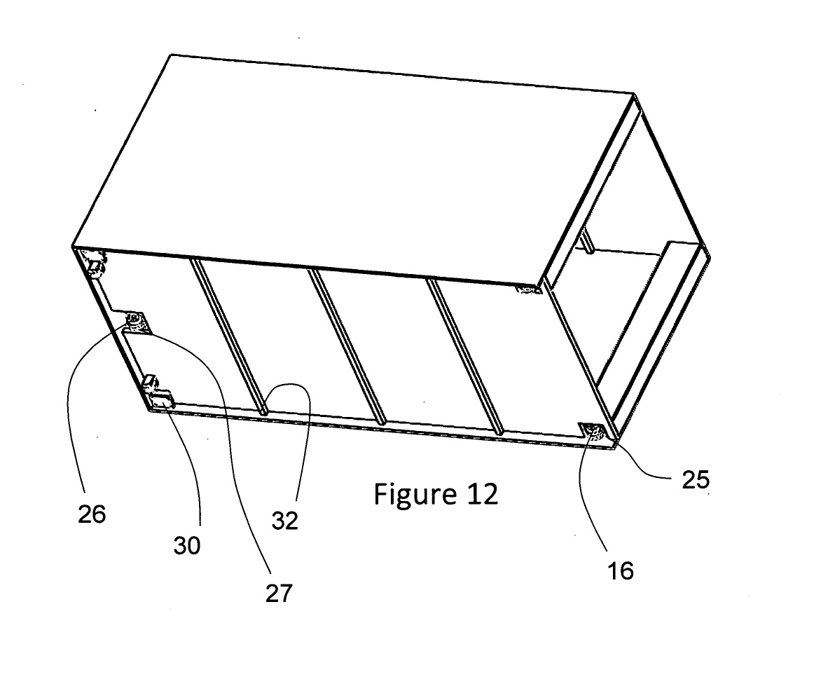

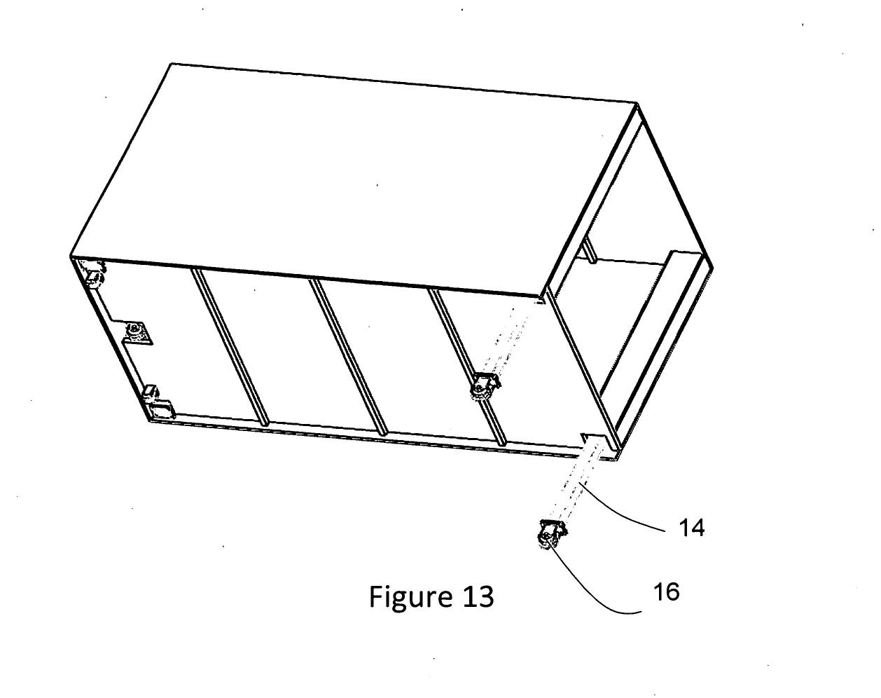

FIG. 11 is a perspective view of the moving container of the invention raised and with the wheel-less legs lowered to secure it into place. Third leg 24 has a purpose in allowing the device of the invention limited motion when raised to allow convenient turning or adjustment of the device's position. In addition, the third leg can be used for leveling, for reverse angle loading and so on. Thus the third leg 24 has third leg wheel 26. The third leg is required in order to achieve the necessary dock high position while keeping the device level.

However, the fourth and fifth legs 28 are in fact wheel-less. Fifth leg 29, 30 wheel-less foot may have a pad or skid. This is to provide stability to the device in the raised position and also to aid in preventing the device from rolling on inclined surfaces.

FIG. 12 is a low-angle perspective view of the moving container of the invention with all legs retracted, showing the apertures of the floor of the container.

Container construction 32 may be seen: while the container may be ISO standard for shipping containers, it is not intended to be a shipping container but rather a moving container and storage container. It may be considered to be the same type of construction as a scaled down dry van container. Thus van-type construction 32 (stringers, laminated hardwood flooring, sheet metal and so on) may be employed, reducing weight and cost and thus further increasing the competitive advantage of the device. This reduction in cost and ease of construction when contrasted to ISO type containers is a huge advantage in the marketplace.

For example, while many variations and embodiments are possible, one typical “van” type construction might use ¼″ sidewalls and roof, along with 1⅜ inch laminated hardwood floors (as the floors must withstand considerable abuse such as the weight of a forklift being driven into the moving container) and flange I beams of 2 to 3″ in width. While this moving container construction is sturdy, it is also inexpensive and extremely cost effective compared to either “Pods”® type devices not built for commercial use or ISO standard shipping containers of much greater expense to build.

There is a marked advantage of this construction over known moving and storage container systems, which cannot be stacked more than three high due to structural considerations: the device of the invention can be stacked at least four high, thus saving space and transport capacity.

Aperture 25 may be seen having therein wheel 16, as leg 14 is presently refracted completely into sleeve 18.

Third leg wheel 26 however refracts into aperture 27. Other legs have similar apertures; the size of the apertures may differ depending upon the construction of the leg.

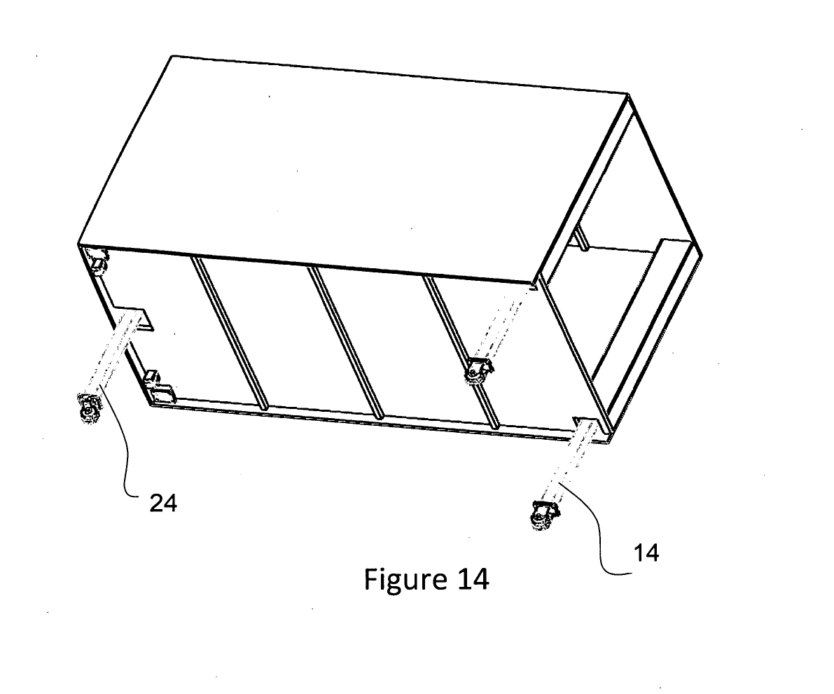

FIG. 13 is a low-angle perspective view of the moving container of the invention with the legs of the second end extended, showing how the moving container may self-level while being raised up an inclined surface such as a standard tow truck bed.

FIG. 14 is a low-angle perspective view of the moving container of the invention with three wheeled legs extended, allowing the moving container to roll on a level surface and also to be used raised to a dock height level.

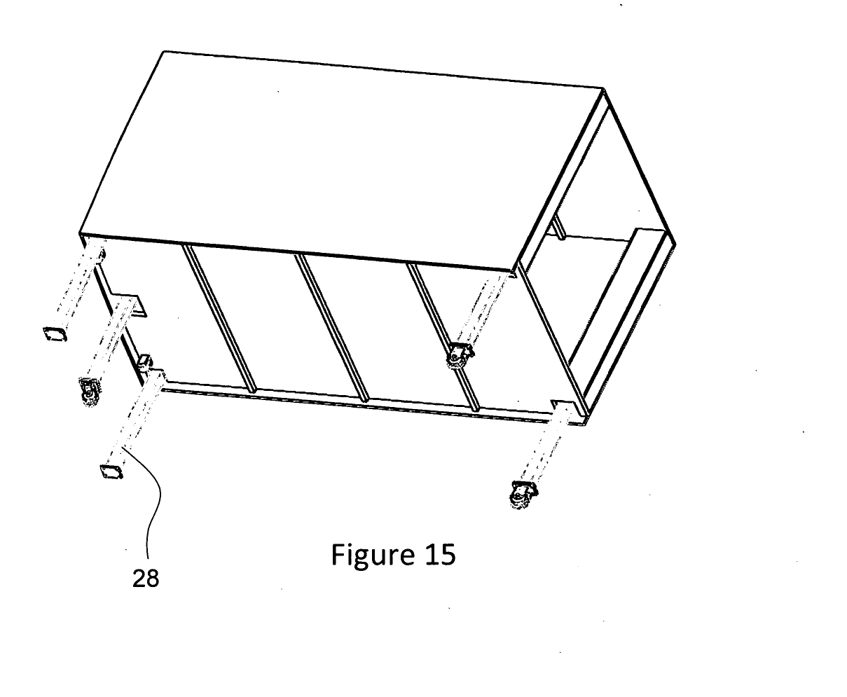

FIG. 15 is a low-angle perspective view of the moving container of the invention with all five legs extended to dock height, holding the container stable and motionless in the elevated position.

In embodiments, the device may have a hard point for connection with cables or the like, it may be provided with exterior advertising, power doors, and extra doors and so on and so forth, and all are within the scope of the present invention.

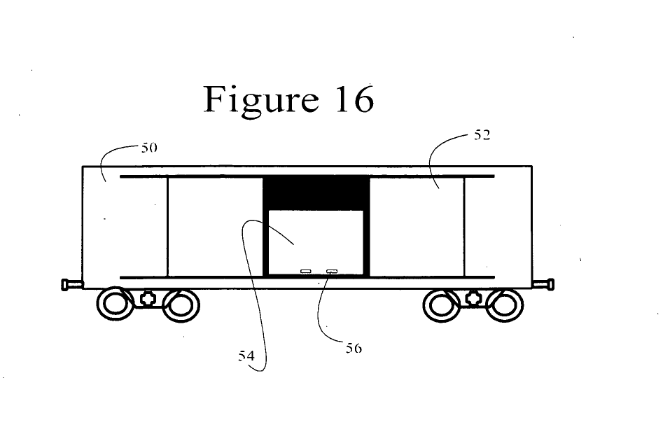

FIG. 16 is a side view of a rail carriage having the doors open to show the self-contained and self-leveling moving and storage container of the invention within. Rail carriage van 50 has wide doors 52 open to show the interior and in the interior of the van, moving and storage container 54. Forklift slots 56 may be seen in this view.

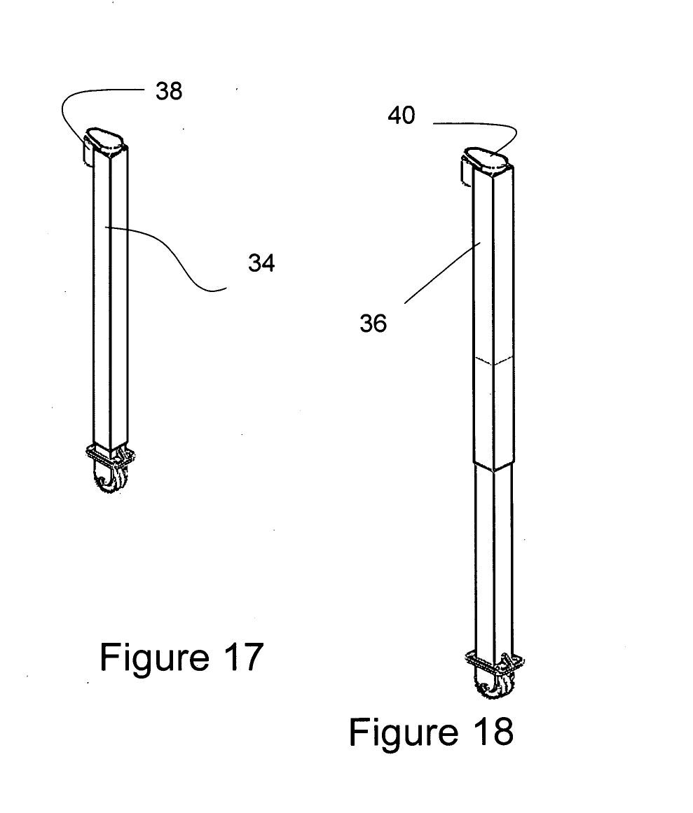

FIG. 17 is a high-angle oblique perspective view of a single retracted leg of the moving container of the invention. FIG. 18 is a high-angle oblique perspective view of a single extended leg of the moving container of the invention. Refracted position leg 34 is of approximately length “C” as defined herein, while extended position leg 36 is of approximately the length necessary to achieve Height=tangent(A)*L+C.

Extension/retraction mechanism 38 is seen, which may be in preferred embodiments an electric motor, a hydraulic device, an engine, an actuator etc. Drive 40 may be gears, worm gears, chains, belts, etc which allow the motion of the mechanism 38 to extend or retract the leg.

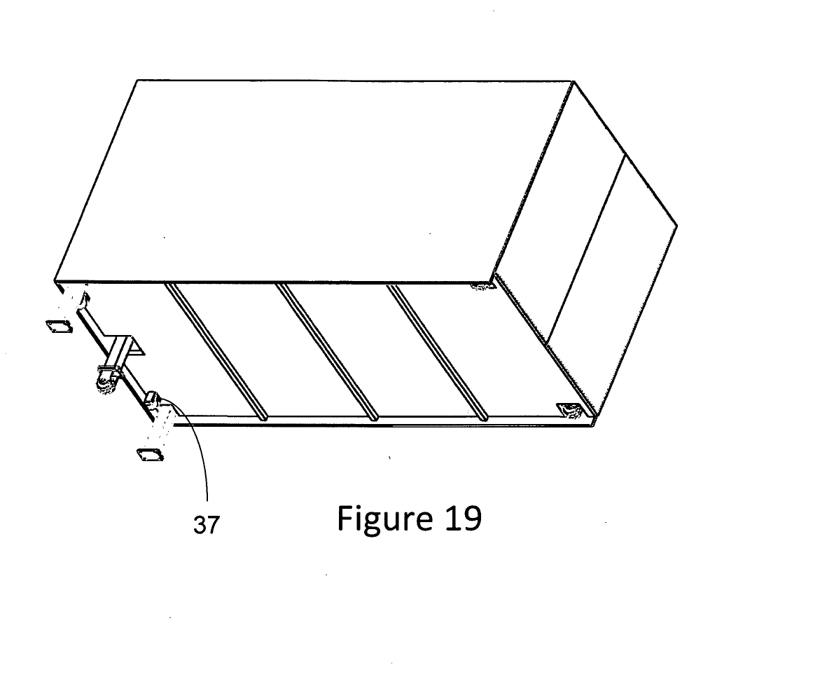

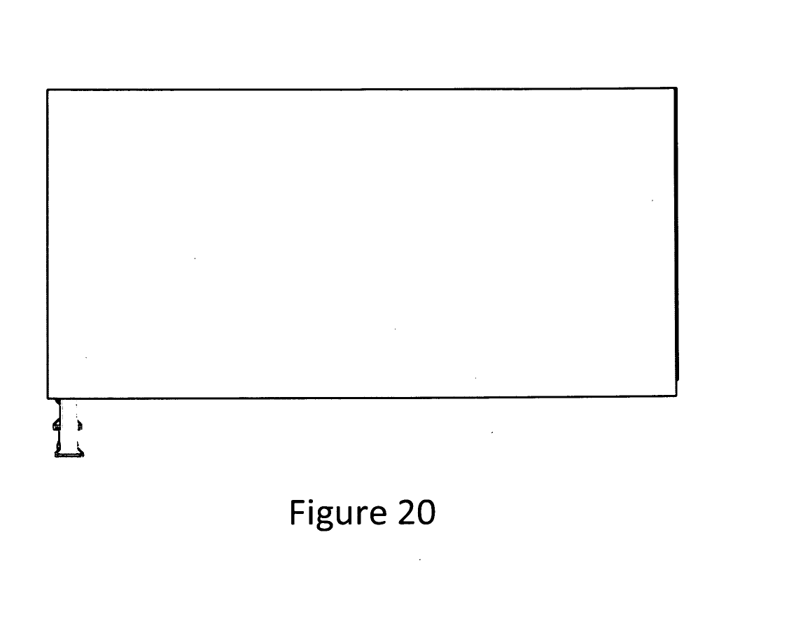

FIG. 19 is a low-angle oblique perspective view of a moving and storage container of the invention showing the legs at one end partially extended to offset the effect of a slanted surface, such as a sloped driveway, a tow truck bed in an intermediate state and so on, while FIG. 20 is a side view of a moving and storage container of the invention showing the legs at one end partially extended to offset the effect of a slanted surface, such as a sloped driveway, a tow truck bed in an intermediate state and so on. In this view the difference between caster 37 and the extendable legs may be seen easily. The casters are not extendable, and as noted may take the form of rollers built into the extreme corner, etc.

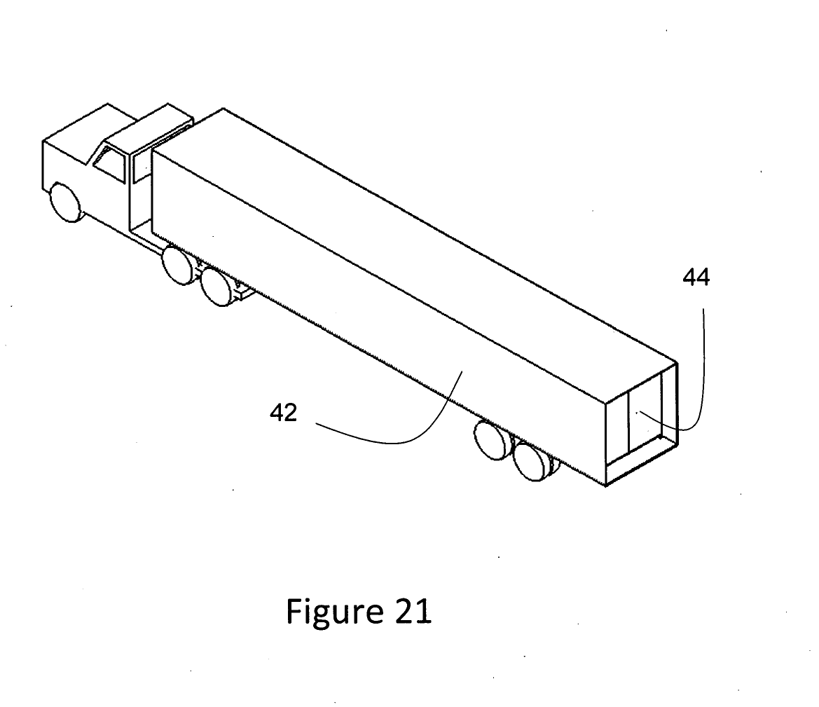

FIG. 21 is a high-angle oblique perspective view of a semi-van 42 and truck with a moving and storage container of the invention loaded therein and the doors omitted to show the moving and storage container 44.

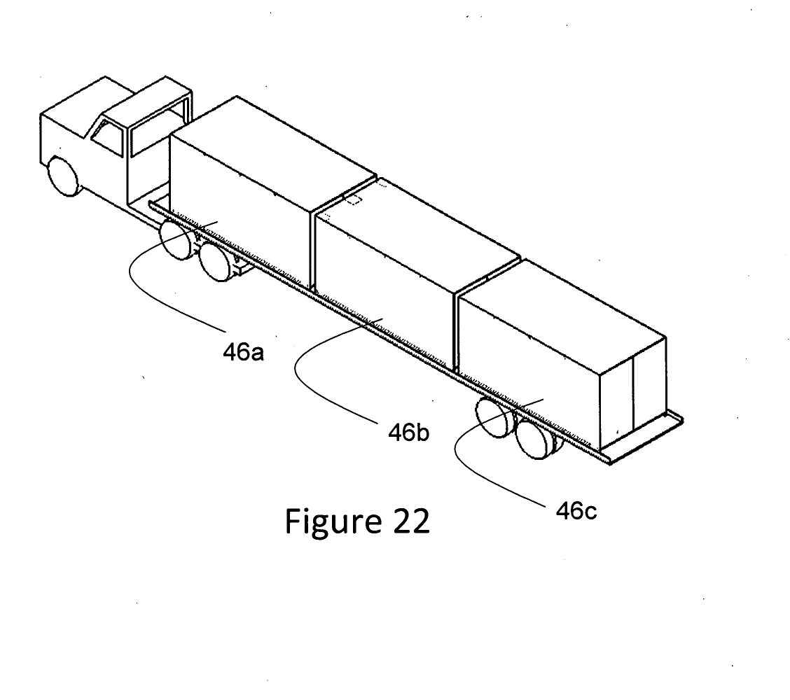

FIG. 22 is a high-angle oblique perspective view of a truck and flat-bed trailer with three of the moving and storage containers of the invention loaded thereon. Containers 46a, 46b and 46c may be seen to fit onto a single flat-bed trailer.

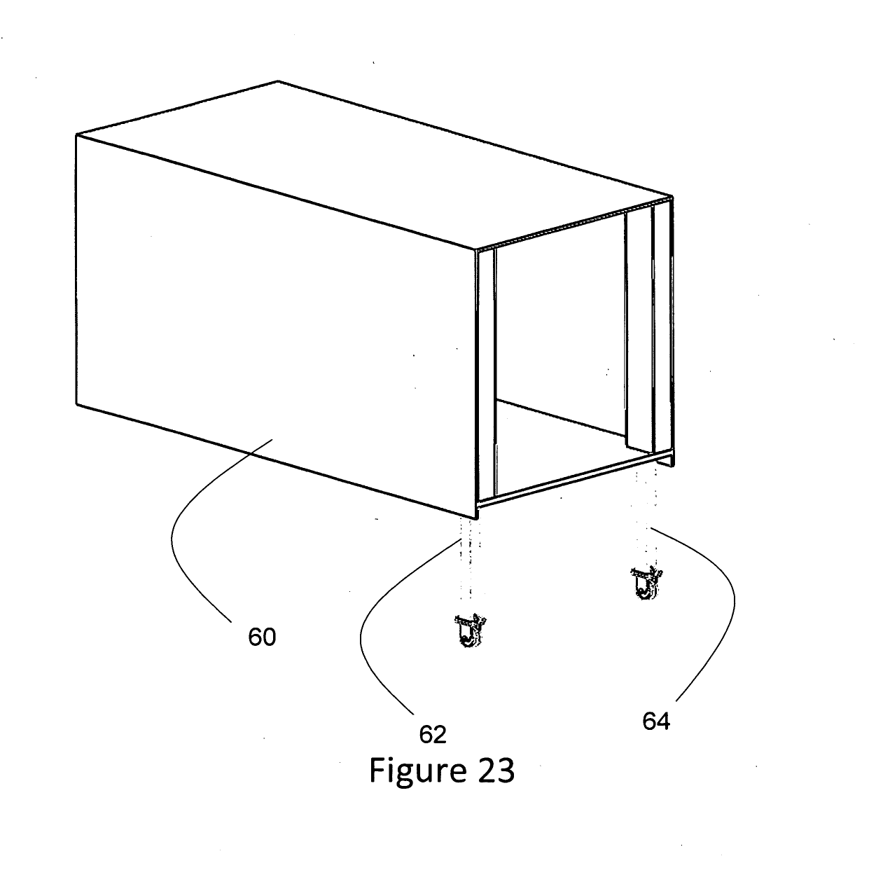

FIG. 23 is a perspective view of another alternative embodiment of the invention having two legs. Moving and storage container 60 has first leg 62 and second leg 64 allowing it to be used in accordance with the method of the invention on a flat-bed tow truck. As with other embodiments, these legs are of a length equal to the tangent of the angle made by the tow truck bed when elevated plus an additional length “C” allowing support and extension/retraction of the leg. The embodiment offers cost advantages but reduced maneuverability to commercial applications. In addition, this embodiment is only level either a) when both legs are refracted and the moving container sits on the ground flat or b) when the container is on the sloped surface of a tow truck bed.

FIG. 24 is a view of a forklift 204 conveying the container from the side, for example to place it on/in a long distance vehicle, and the doors 202 of the invention. Most embodiments do have doors, these are normally omitted in order to show the internal arrangement of the shielding which protects the mechanisms of the legs for retraction.

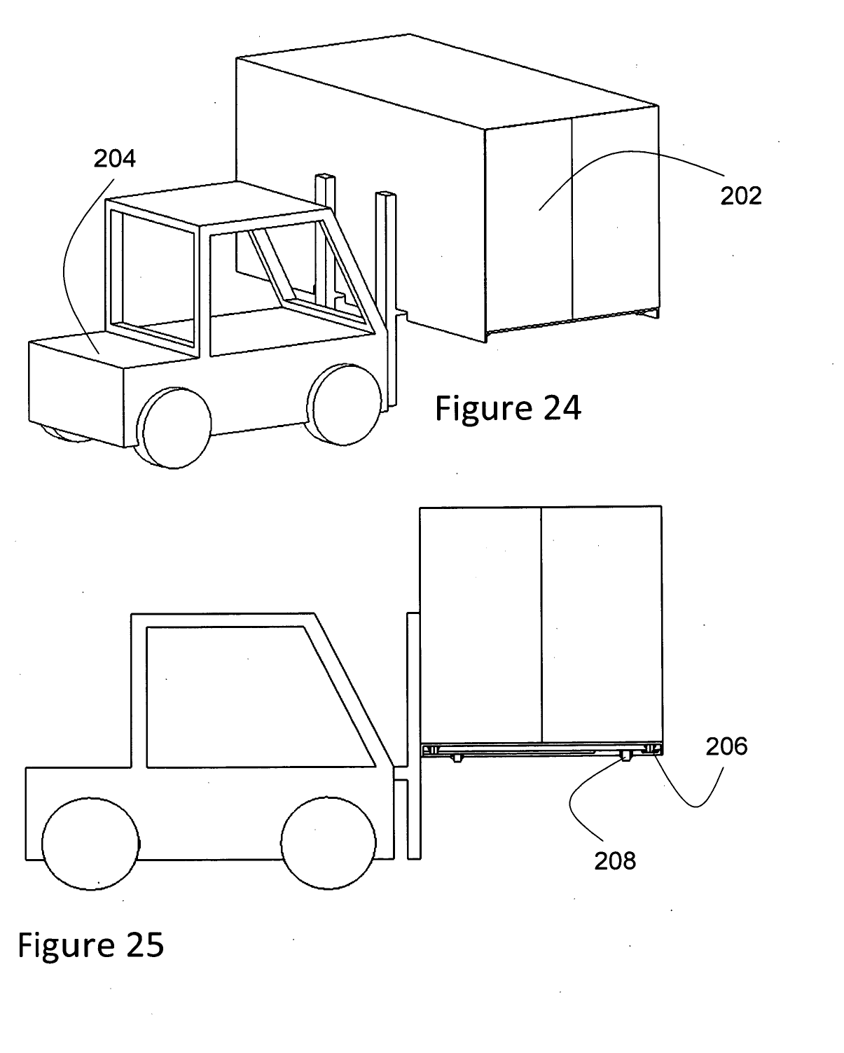

FIG. 25 is a view, end on to the container and side view of a forklift carrying the container of the invention, showing the relative vertical relationship of a refracted leg 206 and a caster 208. It may be seen that in the extended position the leg 206 is longer, but in the retracted position shown, the caster 208 is longer, thus allowing the device to roll up on the caster if the other end is lifted.

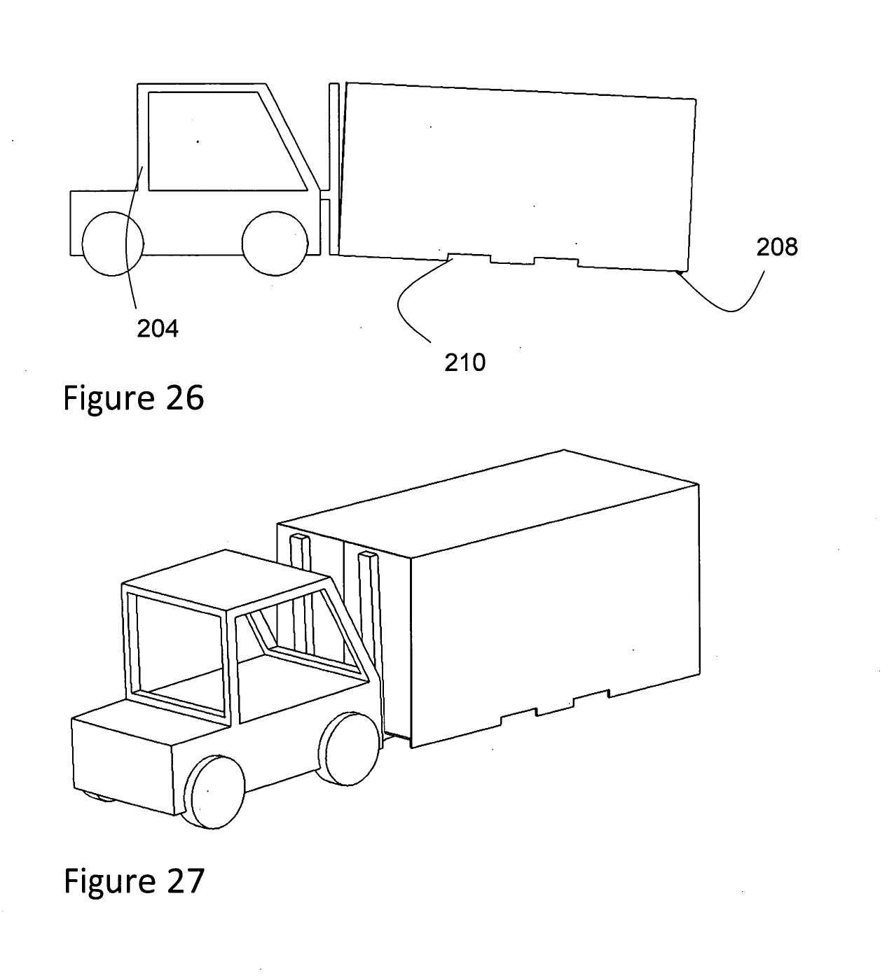

FIG. 26 is a side view of a forklift and container of the invention, showing the handling points (fork lift slots) 210 and how the end furthest from the forklift may roll upon the casters 208.

FIG. 27 is a high angle oblique view showing the handling points (fork lift slots) 210 and how the end furthest from the forklift may roll upon the casters 208.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A self-contained, self-leveling moving and storage container comprising:
a body having first and second ends, having at least one door, a floor four walls and a ceiling forming a right-angled parallelepiped shape with an interior;
the body having at the second end first and second legs, one leg disposed near each corner of the second end, each of the first and second legs having a first retracted position in which the second end of the body is not elevated, and having a second fully extended position in which the second end of the body is elevated, and having the ability to assume any position between the first retracted position and the second fully extended position whereby the container may remain level when the first end is on a surface higher than the second end;
the body having at the first end a third leg; the third leg disposed intermediate the corners of the first end; the third leg having a retracted position in which the first end of the body is not elevated, and having a second fully extended position in which the first end of the body is elevated, and having the ability to assume any position between the first retracted position and the second fully extended position;
the body having at the first end fourth and fifth legs, one leg disposed near each corner of the first end, each of the fourth and fifth legs having a first retracted position in which the first end of the body is not elevated, and having a second fully extended position in which the second end of the body is elevated, and having the ability to assume any position between the first refracted position and the second fully extended position;
each of the legs having an extension/retraction mechanism operative to extend and retract the leg.

2. The moving and storage container of claim one, further comprising:
each of the first and second legs having on the bottom end a wheel;
the third leg having on the bottom end a swivel wheel;
the body having at the first end casters, disposed so as to allow the first end to roll upon the casters when the second end is elevated.

3. The moving and storage container of claim 2, further comprising:
a plurality of apertures through the floor, one aperture disposed at each leg, so that in the refracted positions the legs may extend upward into the body;
a plurality of covers, one cover disposed at each leg, each cover dimensioned and configured to separate its respective leg from the interior of the body.

4. The moving and storage container of claim 2, for use with a standard flat-bed tow truck, the moving and storage container further comprising: an automatic leveling module operative to control the position of at least the first and second legs and further operative to extend, retract, and maintain the position of the first and second legs so as to maintain the body in a level configuration while the body moves along such bed of such flat-bed tow truck despite any tilt of such bed.

5. The moving and storage container of claim 2, for use with a standard flat-bed tow truck, the moving and storage container further comprising: a manual leveling module operative to control the position of at least the first and second legs and further operative to extend and retract the first and second legs so as to maintain the body in a level configuration while the body moves along such bed of such flat-bed tow truck.

6. The moving and storage container of claim 4, wherein each of the fourth and fifth legs has on the bottom end no wheel, and further wherein the automatic leveling module is further operative to control the position of the third leg, and to extend and retract the third leg.

7. The moving and storage container of claim 2, for use with a standard height loading dock, wherein the elevated position further comprises: dock height.

8. The moving and storage container of claim 2, for use with a standard flat-bed tow truck having an ability to tilt such flat-bed to an angle “A”, wherein:
the moving and storage container body further comprises a length “L”,
and wherein the elevated position further comprises a height given by the formula:
height=tangent(A)*L.

9. The moving and storage container of claim 2, further comprising: at least ¼″ thickness sidewalls and roof, 1⅜ inch laminated hardwood floors, and flange I beams of 2″ width.

10. A method of moving and storing items from a first location, the method comprising:
providing a standard flat-bed tow truck having a winch and a rear end of the bed;
providing a storage container having first and second ends, the storage container dimensioned and configured to fit upon the bed of the flat-bed tow truck; the storage container having a first pair of legs located at the second end of the storage container; the storage container disposed upon the bed of the flat-bed truck, the storage container having casters at the first end;
conveying the storage container to such first location;
attaching the winch to the storage container;
tilting the bed of the flat-bed tow truck while extending the first pair of legs;
maintaining the length of the first pair of legs equal to the height of the first end of the storage container as the bed of the tow-truck is tilted;
whereby the storage container remains level despite the increasing tilt of the bed of the flat-bed tow truck;
rolling the container off of the tow truck slowly by means of the winch and the action of gravity;
retracting the first pair of legs so as to maintain the first pair of legs equal to the height of the first end of the storage container on the bed of the flat-bed tow truck as the container rolls off of the rear end of the bed of the tow truck;
whereby the storage container remains level while rolling off of the tow truck to a ground surface;
allowing placement of such items into the storage container.

11. The method of moving and storing items of claim 10, further comprising:
returning the flat-bed tow truck to such first location and moving the rear end of the bed of the flat-bed tow truck to the first end of the storage container;
tilting the bed of the flat-bed tow truck;
attaching the winch to the container;
pulling the storage container up onto the tilted bed of the flat-bed tow truck using the winch, with the first end of the storage container first;
extending the first pair of legs downward from the second end of the storage container;
maintaining the length of the first pair of legs equal to the height of the first end of the storage container as it is pulled up onto the tilted bed of the flat-bed tow truck;
whereby the storage container remains level despite the tilt of the bed of the flat-bed tow truck;
leveling the tilted bed of the flat-bed tow truck while retracting the first pair of legs so as to maintain the length of the first pair of legs equal to the height of the first end of the storage container as the bed of the flat-bed tow truck is leveled;
whereby the storage container remains level despite the leveling of the bed of the flat-bed tow truck;
conveying the storage container from such first location.

12. The method of moving and storing items of claim 11, further comprising:
providing a storage facility;
providing a standard forklift at the storage facility;
conveying the storage container to the storage facility;
lifting the storage container with the standard forklift, conveying it into the storage facility and setting it down;
storing the storage container at the storage facility.

13. The method of moving and storing items of claim 12, further comprising:
providing a second storage container at such facility, the second storage container having the same construction as the storage container; and
wherein the step of lifting and setting down the storage container with the standard forklift further comprises:
stacking the storage container atop the second storage container.

14. The method of moving and storing items of claim 11, further comprising:
providing a long-distance vehicle;
transferring the storage container to the long-distance vehicle by the steps of:
attaching the winch to the storage container;
tilting the bed of the flat-bed tow truck while extending the first pair of legs;
maintaining the length of the first pair of legs equal to the height of the first end of the storage container as the bed of the tow-truck is tilted;
whereby the storage container remains level despite the increasing tilt of the bed of the flat-bed tow truck;
rolling the container off of the tow truck slowly by means of the winch and the action of gravity;
retracting the first pair of legs so as to maintain the first pair of legs equal to the height of the first end of the storage container on the bed of the flat-bed tow truck as the container rolls off of the rear end of the bed of the tow truck;
whereby the storage container remains level while rolling off of the tow truck;
providing a standard forklift;
removing the tow-truck and backing the long-distance vehicle to either side of the storage container;
lifting the storage container onto the long-distance vehicle by using the forklift on one side of the storage container;
conveying the storage container on the long-distance vehicle.

15. The method of moving and storing items of claim 11, further comprising:
providing a long-distance vehicle;
transferring the storage container to the long-distance vehicle by the steps of:
attaching the winch to the storage container;
tilting the bed of the flat-bed tow truck while extending the first pair of legs;
maintaining the length of the first pair of legs equal to the height of the first end of the storage container as the bed of the tow-truck is tilted;
whereby the storage container remains level despite the increasing tilt of the bed of the flat-bed tow truck;
rolling the container off of the tow truck slowly by means of the winch and the action of gravity;
retracting the first pair of legs so as to maintain the first pair of legs equal to the height of the first end of the storage container on the bed of the flat-bed tow truck as the container rolls off of the rear end of the bed of the tow truck;
whereby the storage container remains level while rolling off of the tow truck;
providing a standard forklift and a standard loading dock;
lifting the storage container onto the standard loading dock by using the forklift on one side of the storage container;
removing the tow-truck and backing the long-distance vehicle to either end of the storage container on the standard loading dock;
rolling the storage container into the long-distance vehicle using the forklift to push from the other end of the storage container while allowing the casters to roll;
conveying the storage container on the long-distance vehicle.

16. The method of moving and storing items of claim 11 for use at such first location wherein such first location is a commercial establishment having a loading dock, and further wherein:
the step of allowing placement of such items into the storage container, is preceded by a step of extending the first pair of legs and extending a third leg distal the first two legs so as to raise the container to the height of such commercial facility loading dock, then extending fourth and fifth legs for stability prior to the step of allowing placement of items into the storage container; and further wherein
the step of allowing placement of items into the storage container is followed by a step of simultaneously retracting the first pair of legs and the third leg so as to lower the loaded storage container below the height of such commercial facility loading dock while maintaining the loaded storage container level.

17. The method of moving and storing items of claim 11, for use at a second location, further comprising the steps of:
conveying the storage container to such second location;
attaching the winch to the storage container;
tilting the bed of the flat-bed tow truck while extending the first pair of legs;
maintaining the length of the first pair of legs equal to the height of the first end of the storage container as the bed of the tow-truck is tilted;
whereby the storage container remains level despite the increasing tilt of the bed of the flat-bed tow truck;
rolling the container off of the tow truck slowly by means of the winch and the action of gravity;
retracting the first pair of legs so as to maintain the first pair of legs equal to the height of the first end of the storage container on the bed of the flat-bed tow truck as the storage container rolls off of the rear end of the bed of the tow truck;
whereby the storage container remains level while rolling off of the tow truck;
allowing removal of such items from the storage container.

18. The method of moving and storing items of claim 15, for further use at a second location, the method further comprising;
providing a second standard flat-bed tow truck;
transferring the storage container from the long-distance vehicle to the second flat-bed tow truck by the steps of:
providing a second standard forklift;
pulling the storage container from the long-distance vehicle using the forklift to pull from one end of the storage container while allowing the casters to roll;
lifting the storage container onto the flat-bed tow truck by using the forklift on one side of the storage container;
conveying the storage container to such second location on the second flat-bed tow truck;
tilting the bed of the second flat-bed tow truck while extending the first pair of legs so as to maintain the length of the first pair of legs equal to the height of the first end of the storage container as the bed of the second flat-bed tow truck is titled;
lowering the storage container down from the tilted bed of the second flat-bed tow truck with the second end first;
maintaining the length of the first pair of legs equal to the height of the first end of the storage container as it is lowered down off of the tilted bed of the second flat-bed tow truck;
whereby the storage container remains level despite the tilt of the bed of the flat-bed tow truck bed.

19. The method of moving and storing items of claim 10, wherein the storage container further comprises a normal storage container construction not meeting ISO standards, the storage container dimensioned and configured to fit onto a standard conveyance including but not limited to trailers selected from the group consisting of: standard flat-bed trailers, standard dry van semi-trailers and combinations thereof and within standard size ISO containers.

20. The method of moving and storing items of claim 14, wherein such long-distance vehicle further comprises one member selected from the group consisting of: a standard flat-bed trailer and semi-tractor, a dry van semi-trailer, a train, a ship, an airplane and combinations thereof.

21. A moving and storage container comprising:
a body having first and second ends, having at least one door, a floor four walls and a ceiling forming a right-angled parallelepiped shape with an interior;
the body having at the second end first and second legs, one leg disposed near each corner of the second end, each of the first and second legs having a first retracted position in which the second end of the body is not elevated, and having a second fully extended position in which the second end of the body is elevated, and having the ability to assume any position between the first retracted position and the second fully extended position;
each of the legs having at the bottom end a wheel, the wheel having thereon a swivel.

22. The moving and storage container of claim 21, for use with a standard flat-bed tow truck, the moving and storage container further comprising: a leveling module operative to control the position of at least the first and second legs and further operative to extend, retract, and maintain the position of the first and second legs so as to maintain the body in a level configuration while the body moves along such bed of such flat-bed tow truck.
